(19) United States
(12) Patent Application Publication
(10) Pub. No.: US 2016/0014417 A1
(43) Pub. Date: Jan. 14, 2016

(54) METHODS AND APPARATUSES FOR STRIPE-BASED TEMPORAL AND SPATIAL VIDEO PROCESSING

(71) Applicant: MAGNUM SEMICONDUCTOR, INC., MILPITAS, CA (US)

(72) Inventors: Jack Benkual, CUPERTINO, CA (US); DAN BELL, SAN JOSE, CA (US)

(21) Appl. No.: 14/326,211

(22) Filed: Jul. 8, 2014

(51) Int. Cl. H04N 19/15; H04N 19/48; H04N 19/44

(52) U.S. Cl. CPC H04N 19/15; H04N 19/44; H04N 19/48

(57) ABSTRACT

A technique to reduce memory bandwidth requirements for image and/or video processing systems is described herein. The technique may include retrieving a plurality of images from a memory, and sequentially processing overlapping subsets of the plurality of images to provide a plurality of output images, wherein the output images are spatially and temporally different. Example implementations may include a processor configured to process input images and to provide output images, a buffer coupled to the processor and configured to store a plurality of input images, and a control unit coupled to the buffer and configured to select subsets of input images from the plurality of images to process for a respective output image, wherein each subset of input images from the plurality of images overlaps with a previous and a subsequent subset of input images from the plurality of images.

### TECHNICAL FIELD

Embodiments of the present invention relate generally to video processing and examples of reducing memory bandwidth requirements are described. Examples include methods of and apparatuses for stripe-based temporal and spatial video processing which may reduce memory bandwidth requirements.

### BACKGROUND

Some variations of image and/or video processing may require simultaneous access to multiple sequential images; e.g. frames, as a facet of the underlying image and/or video processing algorithm such as de-interlacing and motion detection to name a couple of examples. Image and/or video processing devices may accordingly retrieve all data required for processing of a current image on-the-fly, including data related to other sequential images, then repeat the process for each subsequently processed image. In the succession of processed images the same input image may be used for multiple output images and may result in the same data being retrieved multiple times to process successive images. The repetitive retrieval of an image to generate multiple output images may increase the frequency of memory accesses. Further, with modern image processing using more and more information due to high resolution cameras and monitors to create images, the size of the data being accessed is also increasing. Thus, with increasing access rates and larger image sizes, the bandwidth required to manage the traffic may exponentially increase. An additional result may be an increase in power expenditure due to the numerous memory accesses.

### BRIEF DESCRIPTION OF THE FIGURES

FIG. 1 is a block diagram of a video processing system according to the present disclosure.

FIG. 2 is a schematic illustration of an example spatial and temporal based video processor for reducing memory requests according to the present disclosure.

FIG. 3 is a flowchart illustrating an example video processing method according to the present disclosure.

FIG. 4 is a schematic illustration of a media delivery system according to the present disclosure.

FIG. 5 is a schematic illustration of a video distribution system that may make use of video processing systems described herein.

### DETAILED DESCRIPTION

Various example embodiments described herein include methods and apparatuses to perform video and/or image processing in stripes and multiplexing the stripes with the parallel processing of multiple input frames. The parallel processing of multiple frames, which may be multiplexed into and out of one or more processing, cores, may avoid or reduce the instances of repeatedly fetching the same input frames for the real-time stripe processing of images and/or video (e.g., frames or fields of a frame) for subsequent images and/or video. A reduction in fetch instances may reduce an overall memory bandwidth requirement of a system. The video and/or image processing tasks performed may be, for example, field comparison, temporal statistics, temporal noise filtering de-interlacing, frame rate conversion, and logo insertion.

As discussed above, conventional real time video processing may read in multiple portions a video (e.g., images, fields of frames, lines of a field or stripes of a field) with some auxiliary data and may output a single processed portion of video (e.g., image, line of a field or image) in addition to some new auxiliary data. A single output may be generated by a processor from multiple input portions (e.g. Images), three for example. The input images and the resulting output image may have a temporal and/or spatial relationship with one another and may be stripes of a composite image, for example fields of a frame. However, each input image, depending on the underlying image processing algorithm, may be used multiple times to generate successive output images. For example, a current output image for time t may use three spatially-related input images from three (or more) consecutive time slices (e.g, times t−k, t, and t+k) to generate an output image for time t. To continue the example, a subsequent image for time t+k may use input images from times t, t+k and t+k+s to generate an output for time t+s. Thus, input images t and t+k may be retrieved twice to produce the two output images. Continue this on and it is apparent that most, if not all, input images are retrieved at least three times for this example processing configuration. The number of times an input image is retrieved, however, may be based on the underlying image processing algorithm or may depend on the number of output images generated per input image retrieval. Hence the number of retrieval times per input image may be even greater than the three in some examples. This repeated fetching of the same data may lead to increased memory bandwidth requirements and increased power consumption of the image processing system due to heat generation.

While examples described herein are discussed in terms of images, it is to be understood that in some examples, other portions of video (e.g. frames, portions of frames, slices, macroblocks) may instead be used. Generally, examples of methods and systems described herein may streamline the accessing of units of video e.g. images, frames, portions of frames, slices, macroblocks) that may be used to generate subsequent units of video.

One solution to reduce memory bandwidth and power consumption may be to reduce the number of image retrievals from a main storage area (e.g., system dynamic access random memory (DRAM), system FLASH storage, system read only memory (ROM), and etc.) while satisfying the data needs for the underlying image processing. Such a solution may fetch data from the main storage area to be used multiple times only once and use it for the processing of all, or multiple, associated output images. The single retrieval of the data from the main storage area may allow the processor to process multiple images per retrieval but may require the retrieval and storage of extra input images. The fetched images may be stored locally to a processing device, in a buffer for example, so that they can be quickly retrieved for processing. This technique may not affect the underlying core processing and may relate to surrounding storage and control of input and output images. For example and in contrast to the example discussed above, if the processor is to generate two output frames at a time, then the processor, or external controlling and buffering logic, may retrieve more than three input images at a time, such as input images associated with the following, times t−k, t, t+k and t+k+s. The retrieval of four input images may allow the image processing device to generate two output images for time t and time t+c. Here, c may be less than or equal to s and their relation may depend on the number of output frames being generated and on the underlying processing algorithm. For example, if three output frames are being generated per input fetch, then five input frames may need to be fetched. Based on the conventional processing method as discussed above two output images would require the retrieval of 6 input images whereas this improved technique may only need to retrieve 4 input images to generate the same two output images, a reduction in image retrievals by two.

The change to the number of input frames fetched from the main memory and the number of output frames generated per fetch may be transparent to the underlying processor and the control of the movement of input and output data may utilize multiplexers controlled by an external input/output logic control. The logic control may cause a number of input images to be retrieved and stored in a buffer local to the processor, which may also receive control signals from the logic control to deliver the correct input images to the processor for the generation of each output image. An output MUX may similarly be controlled to associate related output images/streams with one another. Further control may be based on context information associated with each output image, which may include designation of the input images to fetch/use for each output image and the strength of the processing, for example.

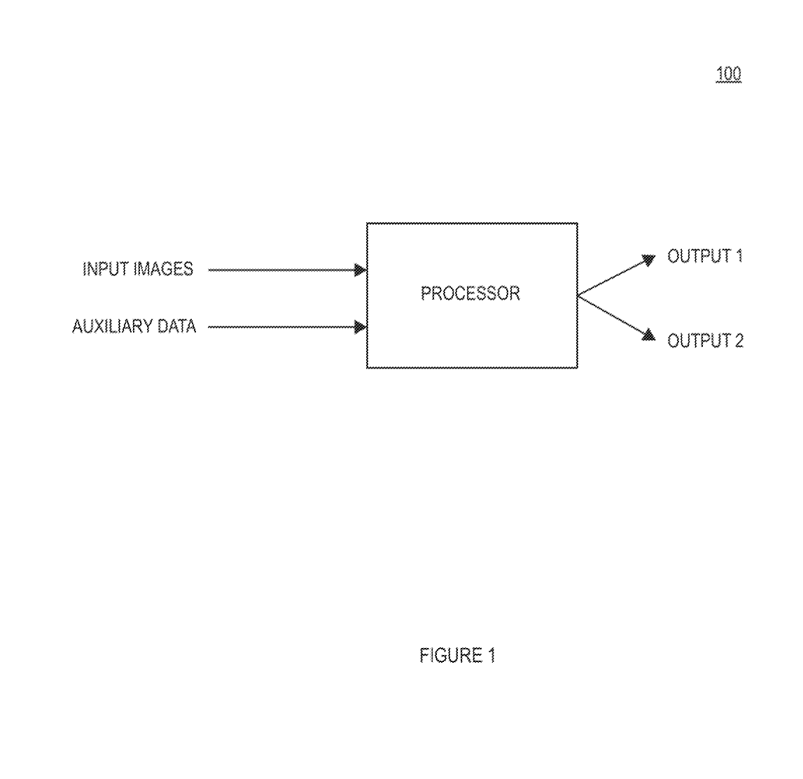

FIG. 1 is a block diagram of a processor 100 arranged according to examples described herein. The processor 100 may receive a plurality of input images (or other portions of video) and auxiliary data used in processing the input images (or other portions of video). The input images may be of varying sizes and may be stripes or raster scans of a composite input image, e.g., a frame or field, which are processed into a plurality of output images by the processor 100. The output images may be processed by the processor 100 such that the pixel values of the output images are dependent upon the pixel values of the plurality of input images used in generating the output image. The pixel values may be combined in any of a variety of ways, including but not limited to, averaging or weighted averaging of the pixel values. The plurality of output images may be formed into a composite output image. The auxiliary data may inform the processor 100 what input images to process to generate an output image. The auxiliary data may also contain processing information such as a strength of processing for an output image, although this may not be necessary and the underlying processing algorithm may not be adjusted by the auxiliary data. The processor 100 may in a single fetch acquire the input images needed to process multiple output images.

The processor 100 may process a subset of the fetched input images to process a first output image before processing a second subset of the fetched images to process a subsequent output image. The first and second subsets of the fetched images may have overlapping images that may be needed to process the sequence of the two output images. For example, if a first output image (output 1 of FIG. 1) uses three input images and a second output (output 2 of FIG. 1) uses two of the same input images plus another input image, then the processor 100 may fetch four input images, e.g. the three used for the first output image plus the other input image needed for the second output image. Thus, the processor 100 may reuse two of the input images. Which input images to process for each output image may be designated by the auxiliary data. The two output images may differ from one another either temporally, spatially or both. As noted above, the processing of multiple output images per fetch may reduce the required memory bandwidth since the number of memory access instances may decrease.

The input images received by the processor 100 may be provided by a memory associated with a system the processor 100 may be included in, such as a broadcast system or a video processing and editing system. The memory, for example, may be system DRAM used and accessed by various other components of the system. Other memory types may be used, FLASH and ROM for example, and the memory type is non-limiting to the current disclosure. The processor 100 may request a plurality of input images and store the plurality of images locally. The locally stored input images may then be used multiple times by the processor 100 before a subsequent request for a more input images may be issued by the processor 100.

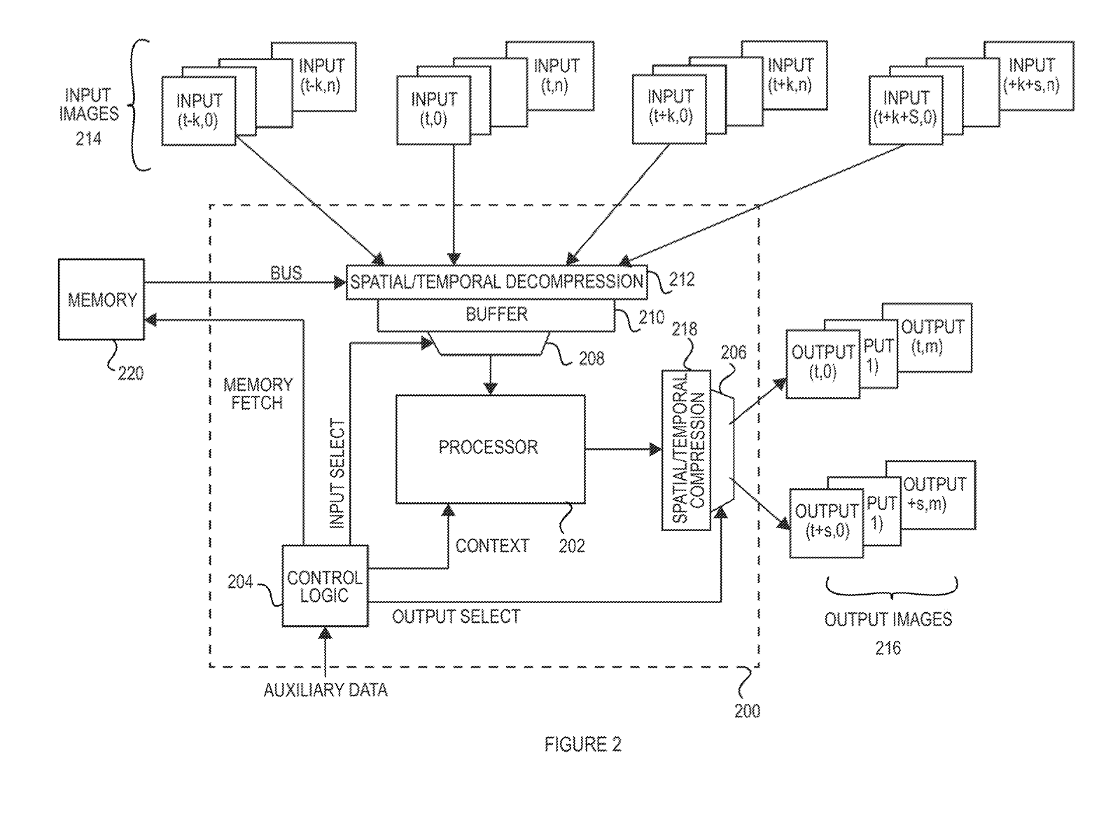

FIG. 2 is a block diagram of a processing system 200 arranged in accordance with examples described herein. The processing system 200 may be used to implement the processor 100 and may implement memory bandwidth reduction and power saving techniques, as described herein, by retrieving multiple input images per memory fetch and processing multiple output images per memory fetch. The processing system 200 may include a processor 202, control logic 204, an input multiplexer (MUX) 208, a spatial/temporal compression unit 218, an output MLA 206, a butler 210, and a spatial/temporal decompression unit 212. The processor 202 may perform any of a variety of processing algorithms, such as field comparison, temporal statistics, temporal noise filtering, de-interlacing, frame rate conversion, logo insertion, or combinations thereof, which may or may not be affected by the surrounding components.

The control logic 204 may receive the auxiliary data, which may be a stream of data or packets of data, and process images in conformance with the auxiliary data. For instance, the auxiliary data may be in the form of a context, which would inform the control logic what input's to fetch for each output image. For example, the context for an output of time t may inform the control logic 204 that input images from time t−k, t and t+k are to be processed to generate the output image for time t. Additionally or alternatively, the context may be broken down into temporal and spatial designations such the context may designate a time and a line or stripe of an image to process. For example, the input images shown in FIG. 2 show two variables in their parenthetical with the first variable associated with a time and the second variable associated with a line or raster number of an image, e.g., the left most images show (t−k,0), (t−k,) through (t−k,n) which may mean all the lines 0−n for an image (e.g. field or other portion of video) for time t−k.

The control logic 204 may read multiple contexts to determine a sequence of input images to retrieve from memory 220 and which of those input images may be re-used. For example, if two sequential output images will be based on some of the same input images, the control logic may have the overlapping or shared images and the non-shared input images all retrieved from the memory 220 over a bus or other interconnect and stored in the buffer 210. The buffer 210 may be local to the processor 202 (e.g. on a same chip or connected with a faster interconnect), accordingly, retrieving data from the buffer 210 may be less resource intensive (e.g. faster) than retrieving data from the memory 220 over the bus. By retrieving all or several of the needed images from the memory 220 based on a single or sequence of fetch commands, the number of overall memory retrievals may be reduced due to the re-use of input images and the negation of multiple retrievals of each input image. The plurality of input images used to process the two sequential output images may be fetched by the control logic 204 or the control logic may send a command to a memory controller (not shown) to retrieve the plurality of input images from the memory 220. The plurality of input images may then be stored in the buffer 210 where they will wait until the control logic sends a control signal to the input MUX 208 to provide the specific input images for a specific output image to be generated by the processor 202. Additionally, if the input images are stored in the memory in a compressed state, then the input images may first be provided to the spatial/temporal decompression unit 212 so that the images may be decompressed before being temporarily stored in the buffer 210. However, if the input images are stored in memory in a decompressed state, then the spatial/temporal decompression unit 212 may be omitted from the processor 200 or may not be used.

The processor 202 provides output images to the output MUX 206. Alternatively or additionally, output images may be provided to the spatial/temporal compression 218 if the output images are to be compressed before being output by the processing system 200, Either way, the output images may be received by the output MLA 206, which may be controlled by the control logic 204. Because the output images may be both temporally and spatially different, the control logic 204 via the output MUX 206 may generate the sequence of output images by their characteristic, e.g., by time. For example, a sequence of output images for a time t and a set of spatial positions (e.g., 0, 1, 2, . . . , m) may be provided to the same output stream by the MUX 206. Similarly, the MUX 206 may generate a sequent of output images for similar spatial positions but for a different time, such as time t+1, and ma provide the sequence of images to a separate output stream. The individual images of the two output streams, for example, may be generated in an interleaved manner by the processor 202 so that the MUX 206 may provide an output image to a first output stream, then provide the next output image to a second output stream—this process of oscillating between the two output streams may continue for all associated spatial images of the two temporally different output streams. As the sequence of input images are processed, the control logic may associate the output images by their respective time variable, for example, so that multiple output streams/images are created with the correct association.

The control logic 204 is depicted to be a part of the processing system 200 but may, alternatively, be associated with another component of a processing system or be a standalone component. Additionally, the buffer 210 may be of various sizes to further decrease the number of memory fetches per output image. FIG. 2 also shows that the control logic 204 provides a context input to the processor 202. If an output image is to be processed differently, e.g., using a different processing strength, then the control logic 204 may provide the processing strength information to the processor 202. However, this connection is not necessary in some examples.

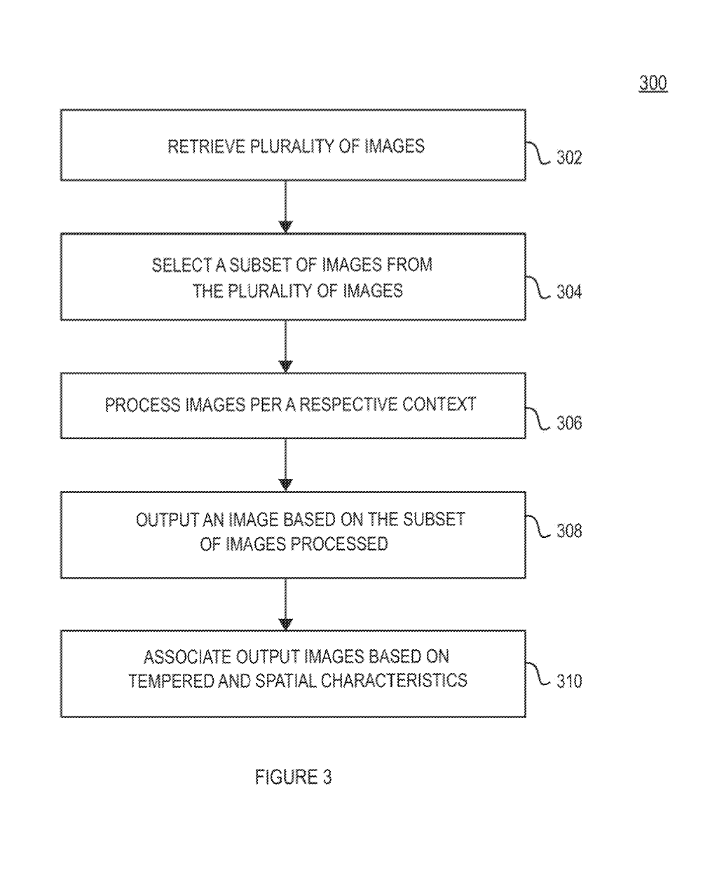

FIG. 3 is an example method 300 for implementing the memory bandwidth saving video processing in accordance with examples described herein. The method 300 could be implemented by the processor 100 or the processing system 200 in some examples. The elements of method 300 will be described in conjunction with components of the processor 200 to provide an example illustration, however other processing, systems may be used in other examples. The control logic 204 may receive a plurality of contexts that inform the processor 200 of what input images to process to generate a plurality of output images. For example, the control logic 204 may receive a context for time t and a context for time t+c. The two contexts may share a subset of input images. Based on the analysis of the two contexts, the control logic 204 may implement step 302 of the method 300 by transmitting a fetch command to a memory controller, for example, which may in turn provide the requested inputs, the plurality of images, to the buffer 210. The fetch command may request input images for times t−k, t, t+k, and t+k+s, a subset of which may be processed to generate the output for time t and the output for time t+c. Additionally, the contexts may designate that the inputs may be for line or raster 0. Thus, as shown in FIG. 2, the four inputs (t−k,0), (t,0), (t+k,0), and (t+k+s,0) may be fetched from the memory and temporarily stored in the buffer 210.

The method 300 continues at step 304 with selecting, a subset of the images from the plurality of images. The control logic 204, based on the context for time t for example, may provide a control signal to the input MUX 208 to connect the inputs associated with the time t context to the processor 202. For example, the three left inputs (t−K,0), (t,0), and (t+k,0) may be delivered to the processor 202 for processing at step 306. The output image may be provided to the output MUX 206 by the processor 202 at step 308. The control logic 204, at step 310, may then provide a control signal to the output MUX 206 to provide the output image to the top output stream, for example.

The processor 202 may then be ready to process a subsequent set of input images to generate another output image. For example, the control logic may transmit a control signal to the input MUX 208 to provide the input images for the time t+c context. The input MUX 208 may then provide the requested input images to the processor 202, e.g., input images (t,0), (t+k,0), and (t+k+s,0). The three input images mini then be processed to generate an output image for time t+s, which is then provided to the output MUX 206. The control logic 204 may transmit a control signal to the output MUX 206 to associate the output for time t+s with a second output stream, the bottom output stream shown in FIG. 2. The two output images generated may be for a first line or raster, e.g., the zero location of an image field, for times t and t+s.

The control logic 204 may read two more contexts that may, for example, be for a subsequent line of images but associated with the same time. The control logic 204 may then, based on the two newly read contexts, transmit a fetch command to the memory for more inputs, such as inputs (t−k,1), (t,1), (t+k,1), and (t+k+s,1). The newly fetched images may overwrite the previously used images in the buffer 210. These four inputs may then be processed according to the method 300 to produce output images (t,1) and (t+s,1). The sequence of events may continue until all n lines of the input images have been processed to generate all in lines of the two output images. The two output images differing temporally in this example.

The preceding example showed three inputs being used to generate one output and those four inputs were fetched to generate two subsequent outputs. The numbers of input images and output images is used only for illustration and are not limitations on the current disclosure. The technique disclosed can be implemented for any number of inputs and outputs. For example, the processing system 200 may generate three output images by fetching five input images. Additionally, the example shows that four input images are simultaneously retrieved to generate the two output images but this is also not necessary for implementing the disclosure. The three images used to produce the first output may be retrieved then the one image still needed to produce the second output could be retrieved once it is needed while retaining the other two images in the buffer.

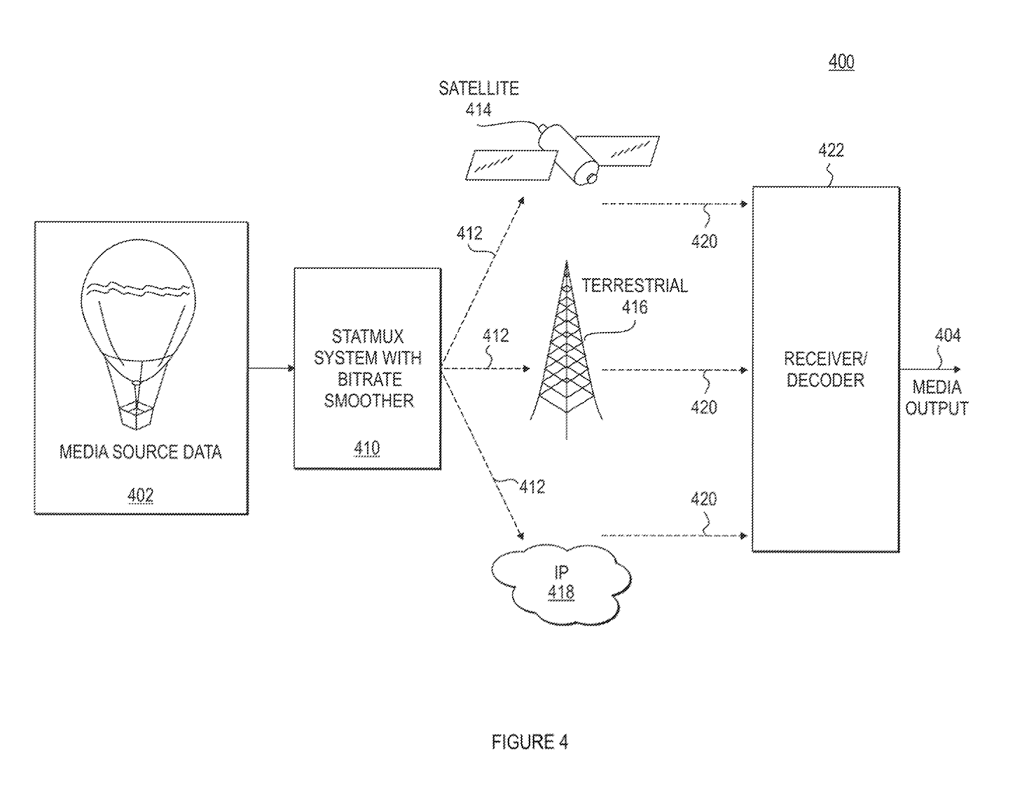

FIG. 4 is a schematic illustration of a media deliver system 400 in accordance with embodiments of the present invention. The media delivery system 400 may provide a mechanism for delivering a media source 402 to one or more of a variety of media output(s) 404. Although only one media source 402 and media output 404 are illustrated in FIG. 4, it is to be understood that any number may be used, and examples of the present invention may be used to broadcast and/or otherwise deliver media content to any number of media outputs.

The media source data 402 may be any source of media content, including but not limited to, video, audio, data, or combinations thereof. The media source data 402 may be, for example, audio and/or video data that may be captured using a camera, microphone, and/or other capturing devices, or may be generated or provided by a processing device. Media source data 402 may be analog and/or digital. When the media source data 402 is analog data, the media source data 402 may be convened to digital data using, for example, an analog-to-digital convener (ADC). Typically, to transmit the media source data 402, some mechanism for compression and/or encryption may be desirable. Accordingly, a video processing system 410 may be provided that may filter and/or encode the media source data 402 using any methodologies in the art, known now or in the future, including encoding methods in accordance with video standards such as, but not limited to, H.264, HEVC, VC-1, VP8 or combinations of these or other encoding standards. The video encoding system 410 may be implemented with embodiments of the present invention described herein. For example, the video encoding system 410 may be implemented using the processing system 200 of FIG. 2.

The encoded data 412 may be provided to a communications link, such as a satellite 414, an antenna 416, and/or a network 418. The network 418 may be wired or wireless, and further may communicate using electrical and/or optical transmission. The antenna 416 may be a terrestrial antenna, and may, for example, receive and transmit conventional AM and FM signals, satellite signals, or other signals known in the art. The communications link may broadcast the encoded data 412, and in some examples may alter the encoded data 412 and broadcast the altered encoded data 412 (e.g. by re-encoding, adding to, or subtracting from the encoded data 412). The encoded data 420 provided from the communications link may be received by a receiver 422 that may include or be coupled to a decoder. The decoder may decode the encoded data 420 to provide one or more media outputs, with the media output 404 shown in FIG. 8. The receiver 422 may be included in or in communication with any number of devices, including but not limited to a modem, router, server, set-top box, laptop, desktop, computer, tablet, mobile phone, etc.

The media delivery system 400 of FIG. 4 and/or the video encoding system 410 may be utilized in a variety of segments of a content distribution industry.

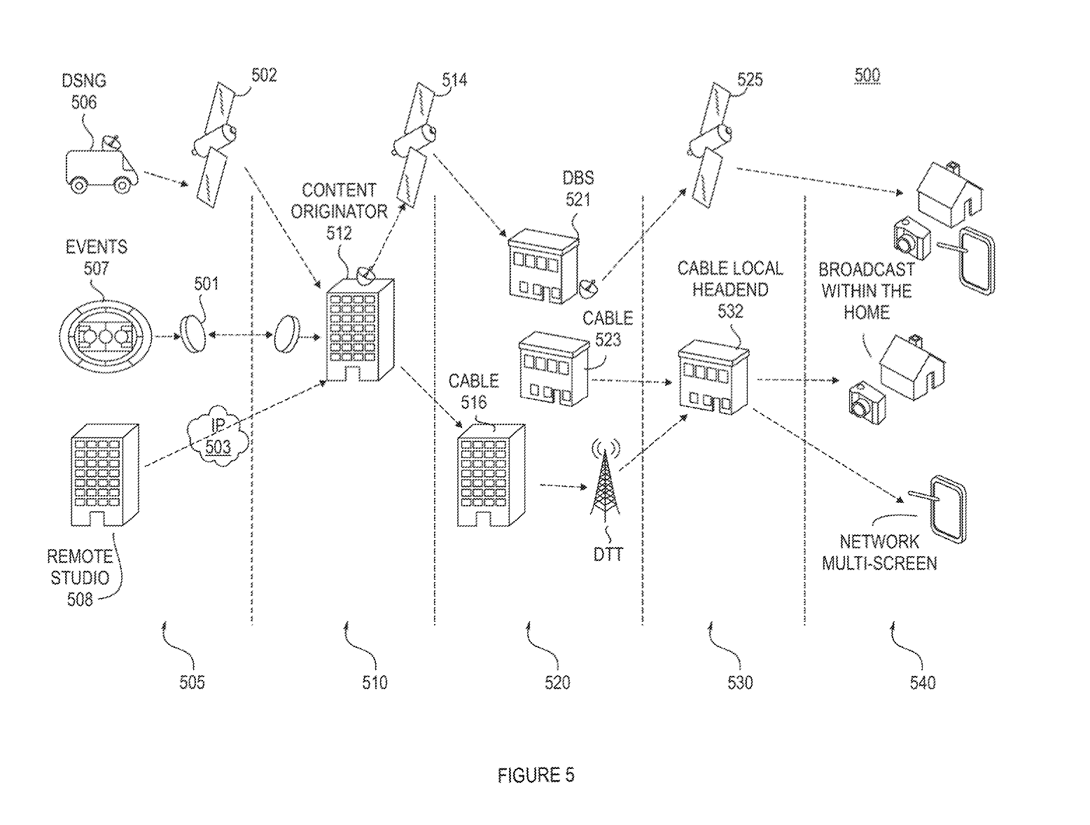

FIG. 5 is a schematic illustration of a video distribution system 500 that may make use of video encoding systems described herein. The video distribution system 500 includes video contributors 505. The video contributors 505 may include, but are not limited to, digital satellite news gathering systems 506, event broadcasts 507, and remote studios 508. Each or any of these video contributors 505 may utilize a video processing systems described herein, such as the processing system 200 of FIG. 2, to process media source data and provide processed data to a communications link. The digital satellite news gathering system 506 may provide encoded data to a satellite 502. The event broadcast 507 may provide encoded data to an antenna 501. The remote studio 508 may provide encoded data over a network 503.

A production segment 510 may include a content originator 512. The content originator 512 may receive encoded data from any or combinations of the video contributors 505. The content originator 512 may make the received content available, and may edit, combine, and/or manipulate any of the received content to make the content available. The content originator 512 may utilize video processing systems described herein, such as the processing system 200 of FIG. 2, to provide encoded data to the satellite 514 (or another communications link). The content originator 512 may provide encoded data to a digital terrestrial television system 516 over a network or other communication link. In some examples, the content originator 512 may utilize a decoder to decode the content received from the contributor(s) 505. The content originator 512 may then re-encode data and provide the encoded data to the satellite 514. In other examples, the content originator 512 may not decode the received data, and may utilize a transcoder to change a coding format of the received data.

A primary distribution segment 520 may include a digital broadcast system 521, the digital terrestrial television system 516, and/or a cable system 523. The digital broadcasting system 521 may include a receiver, such as the receiver 422 described with reference to FIG. 4, to receive encoded data from the satellite 514. The digital terrestrial television system 516 may include a receiver, such as the receiver 422 described with reference to FIG. 4, to receive encoded data from the content originator 512. The cable system 523 may host its own content which may or may not have been received from the production segment 510 and/or the contributor segment 505. For example, the cable system 523 may provide its own media source data 402 as that which was described with reference to FIG. 4.

The digital broadcast system 521 may include a video encoding system, such as the processing system 200 of FIG. 2, to provide encoded data to the satellite 525. The cable system 523 may include a video encoding system, such as the processing system 200 of FIG. 2, to provide encoded data over a network or other communications link to a cable local headend 532. A secondary distribution segment 530 may include, for example, the satellite 525 and/or the cable local headend 532.

The cable local headend 532 may include a video encoding system, such as the processing system 200 of FIG. 2, to provide encoded data to clients in a client segment 540 over a network or other communications link. The satellite 525 may broadcast signals to clients in the client segment 540. The client segment 540 may include any number of devices that may include receivers, such as the receiver 422 and associated decoder described with reference to FIG. 4, for decoding content, and ultimately, making content available to users. The client segment 540 may include devices such as set-top boxes, tablets, computers, servers, laptops, desktops, cell phones, etc.

Accordingly, filtering, encoding, and/or decoding may be utilized at any of a number of points in a video distribution system. Embodiments of the present invention may find use within any, or in some examples all, of these segments.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

What is claimed is:

1. An image processing method comprising:
retrieving a plurality of images from a memory; and
sequentially processing overlapping subsets of the plurality of images to provide a plurality of output images, wherein the output images are spatially and temporally different.

2. The image processing method of claim 1, further comprising selecting a first subset of images from the plurality of images to process based on a first context, wherein the first subset of images produces a first output image of the plurality of output images.

3. The image processing method of claim 2, wherein a context indicates what images to utilize in generating an output image and a strength of processing to apply to the output image.

4. The image processing method of claim 2, further comprising selecting a second subset of images from the plurality of images to process based on a second context, wherein the second subset of images is processed to produce a second output image and the second subset of images includes a portion of the first subset of images.

5. The image processing method of claim 1, further comprising associating output images based on spatial and temporal characteristics of their respective subset of images from the plurality of images.

6. The image processing method of claim 1, further comprising:
spatially and temporally decompressing the plurality of images.

7. The image processing method of claim 1, further comprising storing the plurality of images in a buffer.

8. The image processing method of claim 1, wherein retrieving a plurality of images from a memory comprises:
Providing a fetch command for the plurality of images to the memory; and
Receiving the plurality of images over a bus.

9. An image processing system comprising:
a processor configured to process input images and to provide output images;
a buffer coupled to the processor and configured to store a plurality of input images; and
a control unit coupled to the butler and configured to select subsets of input images from the plurality of images to process for a respective output image, wherein each subset of input images from the plurality of images overlaps with a previous and a subsequent subset of input images from the plurality of images.

10. The image processing system of claim 9, wherein the control unit is further configured to refresh the plurality of input images stored in the buffer after the plurality of input images have been processed.

11. The image processing system of claim 9, wherein the processor is configured to reduce a number of input image retrievals by providing a plurality of output images using a single retrieval of the plurality of input images.

12. The image processing system of claim 9, wherein the control unit is configured to select a subset of input images from the plurality of input images to process based on a context.

13. The image processing system of claim 12, wherein the context indicates the subset of input images to process and a strength of processing for an output image.

14. The image processing system of claim 9, wherein the control unit is further configured to provide output images that are spatially and temporally related in an output stream.

15. The image processing system of claim 14, wherein the output images comprise stripes of a composite image.

16. The image processing system of claim 9, further comprising a memory configured to provide the plurality of input images to the buffer via a bus.

17. The image processing system of claim 9, further comprising an input multiplexer coupled between the buffer and the processor and configured to provide a subset of input images responsive to a control signal provided by the control unit.

18. The image processing system of claim 9, further comprising an output multiplexer configured to receive the output images from the processor and to provide each output image to a respective output stream responsive to a control signal provided by the control unit.

19. An image processing method comprising:
retrieving a plurality of images from a memory; and
processing a plurality of subsets of the plurality of images by an image processor to produce a plurality of respective outputs, wherein subsets of the plurality of subsets overlap with a previous and a subsequent subset of the plurality of subsets and wherein the subsets of the plurality of subsets differ spatially and temporally.

20. The image processing method of claim 19, further comprising:
storing the plurality of images in a buffer;
selecting a first subset of the plurality of images to be processed; and
selecting a second subset of the plurality of images to be processed after the first subset of the plurality of images has been processed.

21. The image processing method of claim 19, wherein a subset of the first subset of the plurality of images is included in the second subset of the plurality of images.

22. The image processing method of claim 19, further comprising:
selecting a first context associated with the first subset of the plurality of images to provide to the image processor; and
selecting a second context associated with the second subset of the plurality of images to provide to the image processor.

23. The image processing method of claim 22, wherein the context includes the subset of the plurality of images to process and a strength of processing to apply to the subset of the plurality of images for a respective output.

24. The image processing method of claim 19, further comprising associating subsequent output images with a previous output image based on a temporal and a spatial relationship.
